(19) United States
(12) Patent Application Publication
(10) Pub. No.: US 2024/0297411 A1
(43) Pub. Date: Sep. 5, 2024

(54) PACKAGING STRUCTURE OF A CYLINDRICAL BATTERY, A CYLINDRICAL BATTERY, A BATTERY PACK, AND A MANUFACTURING METHOD THEREOF

(71) Applicants: Bo WANG, Guangdong Province (CN); Ziqi WANG, Guangdong Province (CN)

(72) Inventors: Bo WANG, Guangdong Province (CN); Ziqi WANG, Guangdong Province (CN)

(21) Appl. No.: 18/117,002

(22) Filed: Mar. 3, 2023

(51) Int. Cl. H01M 50/503; H01M 50/107; H01M 50/169; H01M 50/30; H01M 50/545

(52) U.S. Cl. CPC H01M 50/503; H01M 50/107; H01M 50/169; H01M 50/394; H01M 50/545

(57) ABSTRACT

The present invention relates to a packaging structure of a cylindrical battery, a cylindrical battery, a battery pack, and a manufacturing method thereof. The packaging structure comprises: a cylindrical shell having an open end; a combined top cover comprising a top cover body and a connection transferring piece; wherein the top cover body is a conductor, arranged at the open end of the cylindrical shell and can close the open end; the connection transferring piece has a bending portion, and the two ends of the bending portion serve as a connecting portion and an extending portion of the connection transferring piece respectively; the connecting portion is electrically connected to the top cover body; the extending portion is arranged adjacent to a lateral shell of the cylindrical shell and is not electrically connected to the cylindrical shell; and the outer side of the extending portion is configured to electrically connect to the shell pole of another cylindrical battery. According to the packaging structure and the cylindrical battery in the present invention, the top poles are arranged laterally, thereby a challenge of providing high-flux connections from the top poles of the batteries to a common top busbar and a challenge of increasing the current-carrying capacity of the top common busbar without increasing the height of the top parts of the batteries are overcome, the battery grouping or disassembling efficiency is greatly improved, and the cost is reduced.

### TECHNICAL FIELD

The present invention relates to the field of new energy power batteries, in particular to a packaging structure of a cylindrical battery, a cylindrical battery, a battery pack, and a manufacturing method thereof.

### BACKGROUND OF THE INVENTION

The area of the shell poles of a cylindrical battery is much larger than that of the top poles of the cylindrical battery. Owing to the limitation of the diameter of the top portion, the width of the top busbar between the top poles is much smaller than that of the busbar arranged between the shell poles. As the unit capacity of individual batteries increases and the total capacity of batteries connected in shunt increases, the conventional grouping method of electrically connecting each top pole by means of a common top busbar has put forward high requirements for the conducting branches from the top poles to the common busbar and the current-carrying capacity of the common busbar, and the cross-sectional area of the top common busbar has become a bottleneck of current-carrying. Moreover, the hot welding process has restrictions on the thickness of adjacent hot-melt metal materials. It is an urgent need to increase the width of the busbar since the increase of the thickness of the busbar is limited.

In addition, the application field of grouping of on-board power battery packs for electric automobiles is developing towards CELL-TO-PACK (CTP) technology, which involves high energy density and employs rapid integral grouping (packaging). The unit size of standard cylindrical power batteries in the industry is expanding from Type 21700 (21 mm diameter, and 70 mm height) to Type 46800 (46 mm diameter, and 80 mm height). For the grouping application of large-size cylindrical batteries, especially for the new Type 4680 batteries, CTP and CTC are important technical directions. It is a key challenge for the CTP technology to improve the convenience and reliability of various electrical connection operations in the process of grouping individual batteries into a battery pack; it is crucial for the CTC technology to reduce or optimize the arrangement of functional components outside the battery pack and improve the stability of the battery pack as a structural component of the chassis.

### Contents of the Invention

In order to solve the above problems in the prior art, in one aspect, the present invention provides a packaging structure of a cylindrical battery, including: a cylindrical shell having an open end; a combined top cover comprising a top cover body and a connection transferring piece; wherein the top cover body is a conductor arranged at the open end of the cylindrical shell to close the open end;
the connection transferring piece is a conductor and has a bending portion, and the two ends of the bending portion are a connecting portion and an extending portion of the connection transferring piece respectively; the connecting portion is electrically connected to the top cover body; the inner side of the extending portion is arranged adjacent to a lateral shell of the cylindrical shell and is not electrically connected to the cylindrical shell; and the outer side of the extending portion is configured to electrically connect to the shell pole of another cylindrical battery.

As a preferred technical solution, the top cover body is provided with a pressure relief portion; the pressure relief portion is arranged at the center of the top cover body, or the pressure relief portion is arranged at a position offset from the center of the top cover body.

As a preferred technical solution, an annular electrically connecting structure is provided on the side of the connecting portion that faces the top cover body, and the annular electrically connecting structure electrically connects the top cover body with the connection transferring piece.

As a preferred technical solution, the annular electrically connecting structure a crowned structure.

As a preferred technical solution, the connecting portion and the annular electrically connecting structure are integrally formed, and the annular electrically connecting structure and the top cover body are connected by a hot-welding or cold-welding process.

As a preferred technical solution, the connecting portion, the annular electrically connecting structure and the top cover body are all integrally formed.

As a preferred technical solution, at least a portion of the inner area of the extending portion and/or at least a portion of the inner area of the connecting portion are/is provided with an insulating layer; the insulating layer is configured to insulate the connection transferring piece from the cylindrical shell.

As a preferred technical solution, at least a portion of the inner side of the extending portion is covered with a hard insulating layer, the hard insulating layer is double-sided adhesive.

As a preferred technical solution, the connecting portion is provided with a pressure relief hole at a position corresponding to the pressure relief portion.

As a preferred technical solution, the connecting surface outside the extending portion is a flat surface.

As a preferred technical solution, the connecting surface outside the extending portion is a cylindrical surface, the cylindrical surface is arranged to fit into the shell pole of the adjacent individual cylindrical battery.

In another aspect, the present invention provides a cylindrical battery, comprising any of the above-mentioned packaging structures of the cylindrical battery and a battery cell assembly;

The battery cell assembly is arranged inside a closed space enclosed by the cylindrical shell and the top cover body;

The top pole of the battery cell assembly is electrically connected to the top cover body and/or the connecting portion, the shell pole of the battery cell assembly is electrically connected to the cylindrical shell, and the periphery of the top cover body is connected to the cylindrical shell in an insulated and sealed manner.

In another aspect, the present invention provides a battery bank connected in series, comprising a plurality of cylindrical batteries described above; the plurality of cylindrical batteries are arranged sequentially, the extending portion of the first cylindrical battery in the battery bank serves as an external top pole of the battery bank, the extending portion of each of the other cylindrical batteries in the battery bank is electrically connected to a lateral shell of the cylindrical shell of a previous cylindrical battery sequentially, and the cylindrical shell of the last cylindrical battery in the battery bank can serve as an external shell pole of the battery bank.

As a preferred technical solution, the plurality of cylindrical batteries is arranged in a straight line, a broken line or a curved line.

As a preferred technical solution, the battery bank further comprises a connecting bridge electrically connected to the cylindrical shell of the last cylindrical battery in the battery bank, and the connecting bridge can serve as an external shell pole of the battery bank.

As a preferred technical solution, an electrical bridge structure and/or a cold-welding structure and/or a structural adhesive bonding and encapsulating structure are/is arranged between the extending portion and the lateral shell of the cylindrical shell.

In another aspect, the present invention provides a battery pack, comprising:
a plurality of battery banks arranged in a staggered manner, each of battery banks is consisted of a plurality of cylindrical batteries described above; wherein the cylindrical shells of adjacent cylindrical batteries in the same battery bank are electrically connected; the extending portions of all cylindrical batteries in each battery bank are at the same side of the battery bank and face the lateral shells of the cylindrical shells in the adjacent battery bank; the extending portions of all cylindrical batteries in each battery bank are electrically connected to the lateral shells of the adjacent cylindrical shells in the next battery bank sequentially; all cylindrical batteries in each battery bank are connected with each other in shunt, while the battery banks are connected with each other in series.

As a preferred technical solution, at least one end of each battery bank is provided with a connection transferring bridge; the thickness of the connection transferring bridge is substantially equal to the staggered distance between the battery bank and the adjacent battery bank. As a preferred technical solution, the extending portions of all cylindrical batteries in each battery bank are oriented to a direction that is at the same included angle from the orientation of the battery bank.

As a preferred technical solution, an electrical bridge structure and/or a cold-welding structure and/or a structural adhesive bonding and encapsulating structure are/is provided between the extending portion and the lateral shell of the corresponding cylindrical shell in the adjacent battery bank as well as between the extending portion and the lateral shell of the adjacent cylindrical shell in the battery bank.

As a preferred technical solution, the battery pack comprises an external top pole conflux portion, the external top pole conflux portion is electrically connected to the extending portions of all cylindrical batteries in the first battery bank; alternatively, the battery pack comprises an external top pole conflux structure, the external top pole conflux structure comprises a plurality of external top pole conflux portions that are electrically connected to the extending portions of some cylindrical batteries in the first battery bank respectively.

As a preferred technical solution, the extending portions of all cylindrical batteries in the first battery bank are oriented in a direction perpendicular to the orientation of the battery bank, and the external top pole conflux portion is attached and electrically connected to the extending portions.

As a preferred technical solution, the battery pack comprises an external shell pole conflux portion, the external shell pole conflux portion is electrically connected to the cylindrical shells of all cylindrical batteries in the last battery bank; alternatively, the battery pack comprises an external shell pole conflux structure, the external shell pole conflux structure comprises a plurality of external shell pole conflux portions that are electrically connected to the cylindrical shells of some cylindrical batteries in the last battery bank respectively.

In another aspect, the present invention provides a method for manufacturing the aforesaid battery pack, comprising the following steps:
arranging a plurality of cylindrical batteries in a row in a single-row fixture, and adjusting the orientations of the connection transferring pieces of each of the cylindrical batteries to the same orientation according to the orientations of the connection transferring pieces of the cylindrical batteries;
inserting a cold-welding structure between the cylindrical shells of adjacent cylindrical batteries in the battery bank, and pressing from the two sides to form a linear battery bank in a fixed length, wherein the cylindrical shells of all cylindrical batteries in the battery bank are connected in shunt;
preparing a plurality of battery banks;
arranging the plurality of battery banks in a staggered manner in the whole fixture, inserting a cold-welding structure between the cylindrical shells of the adjacent battery banks and the extending portions, pressing the plurality of battery banks together in the inter-bank direction, so that the cylindrical shells of corresponding cylindrical batteries in adjacent battery banks are connected to the extending portions, so as to obtain a battery pack in which adjacent battery banks are connected in series.

The above technical solution can achieve the following beneficial effects: the top poles of the cylindrical batteries are arranged laterally by means of the electrical connection relationship among the top cover body, the connecting portion and the extending portion, so that the top pole can be electrically connected to the shell pole on a lateral shell of the adjacent battery conveniently; besides, the common top busbars of individual battery banks are merged into a common shell pole busbar (laterally arranged and shared) for adjacent battery banks that are connected in series, thereby the challenge of increasing the current-carrying cross-sectional area of the common top busbars under a high flux condition as well as the challenge of increasing the current-carrying capacity of the top common busbars without increasing the height of the top portions of the batteries are overcome, and the grouping and banking process of cylindrical batteries are greatly simplified.

Besides, in the grouping process, an electrical connection in series or in shunt and an overall structural bonding and encapsulation could be achieved by a crimping electrical connection of an overall packing (cold-welding adhesive) and a pure bonding process of application of structural adhesive to the whole, thereby the grouping efficiency is greatly improved, and the cost is reduced; individual batteries and corresponding components can be recycled intactly with a chemical disassembling method from a battery pack that is packaged through a pure bonding process, thereby the disassembling cost is greatly reduced, and the recycling rate of batteries and components is increased, so as to save the social resources.

In addition, since there is no external common busbar structure at the top end or bottom end of the battery pack, it is helpful for reducing the impact of external vertical pressure on the electrical connections of the common busbars and the structural strength of the battery pack, and improving the integral strength of the battery pack and the chassis structure of the vehicle.

### BRIEF DESCRIPTION OF THE DRAWINGS

In order to explain the technical solutions of the embodiments of the present invention more clearly, hereunder the accompanying drawings, which will be used in the description of the embodiments and constitute a part of the present invention, will be described briefly. The exemplary embodiments of the present invention and associated description are intended to explain the present invention but don't constitute any undue limitation to the present invention. In the figures:

FIG. 1 is a schematic diagram of the packaging structure of the cylindrical battery disclosed in Embodiment 1 of the present invention;

FIG. 2 is a schematic diagram of the packaging structure of the cylindrical battery disclosed in Embodiment 1 of the present invention;

FIG. 3 is a schematic diagram of the packaging structure of the cylindrical battery disclosed in Embodiment 1 of the present invention;

FIG. 4 is a schematic diagram of the packaging structure of the cylindrical battery disclosed in Embodiment 1 of the present invention;

FIG. 5 is a schematic diagram of the cylindrical battery packaging structure disclosed in Embodiment 1 of the present invention;

FIG. 6 is a schematic diagram of the packaging structure of the cylindrical battery disclosed in an Embodiment 1 of the present invention;

FIG. 7 is a schematic structural diagram of the battery bank in series disclosed in Embodiment 3 of the present invention;

FIG. 8 is a schematic structural diagram of the battery pack disclosed in Embodiment 4 of the present invention;

FIG. 9 is a schematic structural diagram of the battery pack disclosed in Embodiment 4 of the present invention;

FIG. 10 is a schematic structural diagram of the battery pack disclosed in Embodiment 4 of the present invention;

FIG. 11 is a schematic structural diagram of the battery pack disclosed in Embodiment 4 of the present invention.

### DESCRIPTION OF THE REFERENCE NUMBERS

10-combined top cover; 11-top cover body; 111-pressure relief portion; 112-insulating gasket; 12-connecting portion; 121-pressure relief hole; 122-annular electrically connecting structure; 13-extending portion; 14-insulating layer;

20-cylindrical shell;

30-connection transferring bridge;

40-connecting bridge;

50-first electrically connecting portion;

60-second electrically connecting portion;

70-structural adhesive.

### EMBODIMENTS

To make the object, technical solutions, and advantages of the present invention understood more clearly, hereunder the technical solutions of the present invention will be detailed clearly and completely in conjunction with embodiments, with reference to the corresponding accompanying drawings of the present invention. In the description of the present invention, it should be noted that the term “or” is usually used with the meaning of including “and/or”, unless otherwise indicated explicitly in the context.

In order to solve the problems existing in the prior art, in the embodiments of the present invention, a packaging structure of a cylindrical battery, a cylindrical battery, a battery pack, and a manufacturing method thereof are provided.

The conventional structure of top cover and pressure relief valve is changed into an integral structure of a top cover, a pressure relief valve and a connection transferring piece, so as to form a novel battery packaging structure with laterally arranged top poles, and further provide a novel cylindrical battery structure, a novel battery pack grouping structure and method based on the packaging structure.

### Embodiment 1

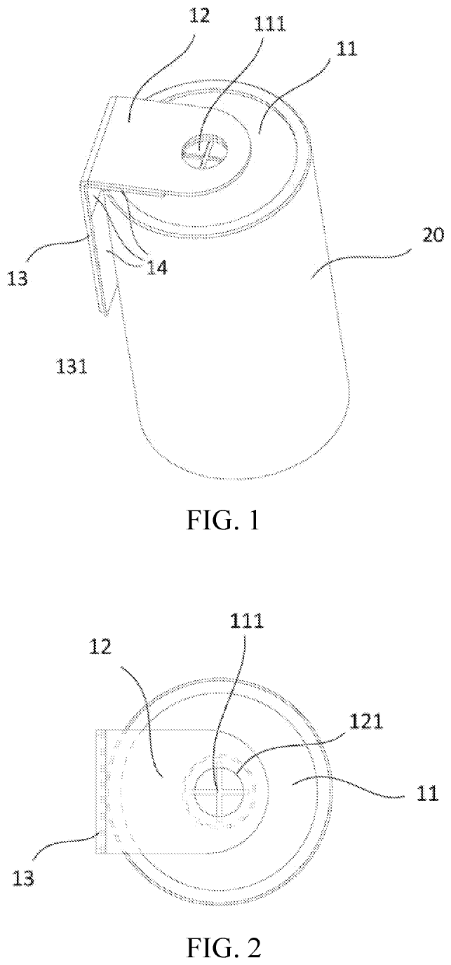

As shown in FIGS. 1-6, in Embodiment 1, a packaging structure of a cylindrical battery is provided, comprising:
a cylindrical shell 20 having an open end; the open end is circular, corresponding to the position of the top pole of the cylindrical battery, which is also called the top of the cylindrical battery in the embodiment. The bottom of the cylindrical battery is a closed end.

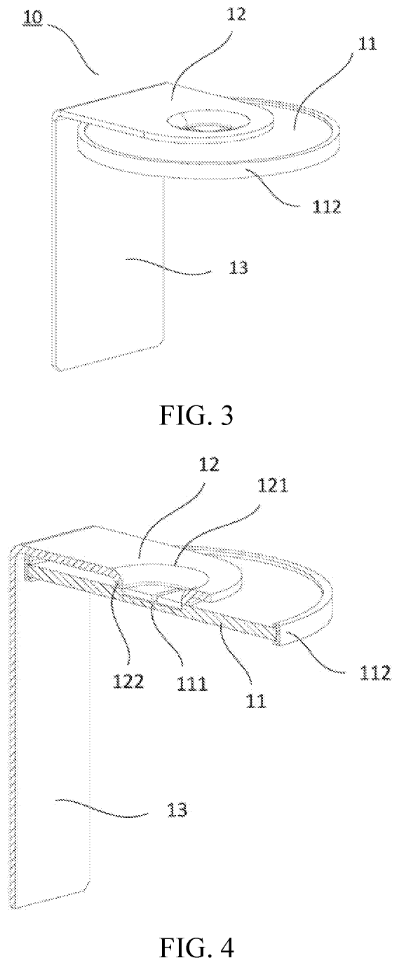

Significantly different from the top cover of an existing cylindrical battery, in the Embodiment 1, the combined top cover 10 shown in FIGS. 3-4 is employed, and the combined top cover 10 comprising a top cover body 11 and a connection transferring piece.

Wherein, the top cover body 11 is made of a conductive material, preferably in the shape of a disk, and is arranged at the open end of the cylindrical shell 20, matches the open end in shape, and can close the open end; preferably, an insulating gasket 112 is provided on the periphery of the top cover body 11, to provide functions of insulation, sealing, fixing and spacing.

The structure of the combined top cover 10 further has a connection transferring piece, preferably in a strip shape. The connection transferring piece has a bending portion, and the two ends of the bending portion serve as the connecting portion 12 and the extending portion 13 of the connection transferring piece respectively, and the bending angle is preferably 90 degrees, which is to say, the connecting portion 12 is substantially perpendicular to the extending portion 13. As shown in FIG. 4, the connecting portion 12 is electrically connected to the top cover body 11.

The extending portion 13 is arranged adjacent to the lateral shell of the cylindrical shell 20 and is not electrically connected to the cylindrical shell 20; the outer side of the extending portion 13 is configured to electrically connect to the shell pole of other cylindrical batteries.

In the Embodiment 1, the top pole of the cylindrical battery is laterally arranged by means of the relationship of electrical connection among the top cover body 11, the connecting portion 12 and the extending portion 13. The structure of the combined top cover 10 can be completed before the cylindrical batteries are grouped and assembled, which is to say, the cylindrical battery prepared with the packaging structure in the Embodiment 1 has a top pole laterally arranged after the battery is manufactured, which will provide great convenience for the banking and grouping of the cylindrical batteries.

Preferably, the top cover body 11 has a pressure relief portion 111. Preferably, the pressure relief portion 111 is arranged at the center of the top cover body 11. In the packaging structure in the embodiment 1, the pressure relief portion 111 arranged on the top cover of the battery and the pressure relief hole 121 above the pressure relief portion 111 can be reserved. Preferably, the pressure relief portion 111 is a cross-shaped slot.

In another preferred technical solution, the pressure relief portion 111 may be arranged at a position offset from the center of the top cover body 11.

In this embodiment, a plurality of pressure relief portions 111 may be provided. Preferably, the pressure relief portion 111 is located in an area of the top cover body 11 that has locally reduced thickness, such as a local linear recess or circular recess, etc.; alternatively, the pressure relief portion 111 may be a separate pressure relief component.

Preferably, a pressure relief opening portion is arranged above the pressure relief portion, and comprises a cylindrical side wall and a top end of a pressure relief channel. Preferably, the top end is open, and the opening is an upward pressure relief opening; or the top end is a cover plate closed with the lateral wall of the pressure relief channel; the lateral wall of the pressure relief channel has an opening, which is a lateral pressure relief opening; the pressure relief opening portion is a conductor and electrically connected to the top cover body. Preferably, the lateral wall of the pressure relief channel has a certain thickness, serves as an electrical connecting portion between the cover plate and the top cover body 11 and can withstand a high electrical flux.

Preferably, an annular electrically connecting structure 122 is provided on the side of the connecting portion 12 that faces the top cover body 11, and the annular electrically connecting structure 122 electrically connects the top cover body 11 with the connection transferring piece. Preferably, the annular electrically connecting structure 122 is a crowned structure. According to the cross-sectional structure shown in FIG. 4, the crowned structure preferably is formed by punching and outwardly bending the surface of the connecting portion 12 preferably through an edge-flanging process, in which the pressure relief hole 121 is produced at the same time. Even if the surface of the connecting portion 12 has the pressure relief hole 121, the electrical flux capacity of the connecting portion 12 at the area with the pressure relief hole 121 will not be affected.

Preferably, the crowned structure may be understood as a downwardly flanged edge of the connecting portion 12 at the pressure relief hole 121, with several shallow cuts at the lower end of the downwardly flanged edge. An annular electrical contact claw can be formed when the lower end is expanded and broken; preferably the electrical contact claw is bent outwardly. The downwardly flanged edge of the crowned structure is the lateral wall of the pressure relief channel, and the hollow part of the crowned structure is the upward pressure relief opening. Those skilled in the art can easily understand that the annular electrical contact claw can significantly increase the electrical contact area between the connecting portion 12 and the top cover body and is more suitable for Type 4680 batteries that have high energy density.

The connecting portion 12 and the annular electrically connecting structure 122 of the connection transferring piece prepared through such a process are integrally formed. Those skilled in the art can easily understand that an integrally formed connection transferring piece can be obtained through another process such as a casting process instead of the punching process, and the electrical connection will be more reliable through such a process.

Preferably, the annular electrically connecting structure 122 and the top cover body 11 are connected by a hot-welding or a cold-welding process.

As a preferred embodiment, the hot-welding process is a connection process with a metal fusing or fusing of packing materials, including one or more of spot welding, laser beam welding, ultrasonic welding, and argon arc welding, and is usually used to prepare the electrical connection of the combined top cover 10. Since the combined top cover 10 is prepared before the cylindrical battery is manufactured, the use of the hot-welding process will not bring any adverse effect on the thermal stability of the cylindrical battery manufactured through the subsequent process.

As a preferred embodiment, the cold-welding process is to apply cold-welding adhesive between the annular electrically connecting structure 122 and the top cover body 11 to form a stable electrical connection between them, and is usually used to form an electrical connection between the top cover and the connection transferring piece of a finished battery. The cold-welding adhesive preferably is conductive adhesive that is curable at normal temperature. An electrical connection is formed by pressing the connecting portion downward, the cold-welding adhesive fills up the non-contact points of the pressed part and overspills to the joint of the outer surface not being pressed after the cold-welding adhesive is pressed. Thus, the electrical contact area is greatly increased.

In another preferred embodiment, the connecting portion 12, the annular electrically connecting structure 122 and the top cover body 11 are integrally formed, for example, the combined top cover 10 is prepared through a casting process.

In another preferred embodiment, at least a portion of the area of the connecting portion fits into the top cover body and is electrically connected to the top cover body. Preferably, at least a portion of the area of the connecting portion 12 is integrally formed with the top cover body 11, so as to provide better electrical connection performance and higher structural strength. Preferably, the end of the connecting portion has a through-hole, the inner wall of the through-hole is the inner wall of the lateral wall of a pressure relief channel; the upper surface of the top end of the pressure relief opening portion is flush with the top surface of the connecting portion, and the through-hole is an upward pressure relief opening of the pressure relief opening portion; or the top surface of the through-hole is closed, and the connecting portion is provided with a lateral pressure relief opening in a direction not towards the bending portion.

Preferably, at least a portion of the inner area of the extending portion 13 and/or at least a portion of the inner area of the connecting portion 12 are/is provided with an insulating layer 14. As shown in FIG. 1, preferably, the inner side of the extending portion 13 corresponding to the lateral shell is covered with the insulating layer 14, and preferably, an inner side of the extending portion 13 near to the bending portion and the inner side of the extending portion 13 away from the bending portion are provided with different insulating layers 4. For example, the inner side of the extending portion 13 near the bending portion is covered with a hard insulating layer 14, which is double-sided adhesive; while at the end area away from the bending portion, the lateral shell corresponding to the hard insulating layer 14 is provided with one-sided adhesive, and the extending portion 13 at that section is not bonded to the hard insulating layer 14, so that the extending portion 13 at that section can be bent outwardly conveniently to form an external top pole of the battery. Preferably, after the double-sided adhesive is cured, the upper portion of the extending portion 13 is integrally formed with the side of the cylindrical shell.

At least a portion of the inner area of the connecting portion 12, that is, an area of the connecting portion 12 that faces the top cover body 11, is also provided with the hard insulating layer 14 to avoid a short circuit between the positive pole and the negative pole of the battery incurred by the connection transferring piece. Preferably, in the Embodiment 1, the area of the top end of the lateral shell corresponding to the connecting portion 12 near the bending portion is provided with the hard insulating layer 14;

Preferably, in the Embodiment 1, the insulating layer 14 is made of a wear-resistant and hard material, such as a piece of thick highland barley paper or a thin epoxy plate or a cured insulating adhesive layer;

Preferably, as shown in FIGS. 3-4, the extending portion 13 is an elongate flat plate; preferably, the outer connecting surface of the extending portion 13 is a flat surface.

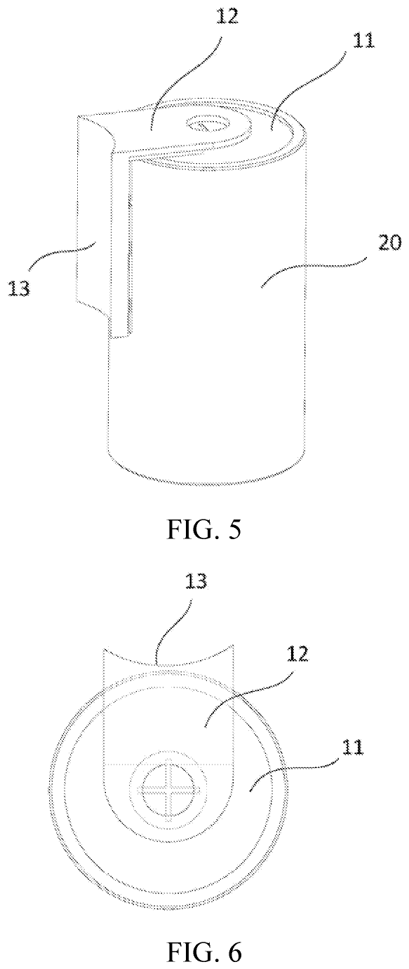

As another preferred embodiment, as shown in FIGS. 5-6, the outer connecting surface of the extending portion 13 is a cylindrical surface, and the cylindrical surface is arranged to fit into the shell pole of the adjacent cylindrical battery, so as to increase the area of contact with the lateral shells of other cylindrical batteries and increase the power receiving capacity. Preferably, the radius of the cylindrical surface of the outer connecting surface of the extending portion 13 is equal to the radius of the cross section of the cylindrical shell 20.

### Embodiment 2

In Embodiment 2, a cylindrical battery is provided and the cylindrical battery employs the packaging structure of the cylindrical battery in the Embodiment 1, and has a battery cell assembly, the battery cell assembly is arranged in a closed space enclosed by the cylindrical shell 20 and the top cover body 11. It should be understood by those skilled in the art that there is not particular restriction on the battery cell assembly in the Embodiment 2, which is to say, any conventional type of battery cells existing in the art can be used in the Embodiment 2; for example, conventional lithium-ion battery cells in the art can be used.

The top pole of the battery cell assembly is electrically connected to the top cover body and/or the connecting portion, the shell pole of the battery cell assembly is electrically connected to the cylindrical shell, and the periphery of the top cover body is connected to the cylindrical shell in an insulated and sealed manner. Those skilled in the art should understand that the top pole of the battery cell assembly may be electrically connected to the top cover body; alternatively, in some preferred technical solutions, the top pole of the battery cell assembly may be directly and electrically connected to the connecting portion.

The cylindrical battery in the Embodiment 2 has a top pole laterally arranged, which is beneficial for grouping the batteries by connecting them in series or in shunt. Therefore, the cylindrical batteries are especially suitable for preparing power battery units for new energy vehicles, and meet the development trend of CTP and CTC.

In the Embodiment 2, the cylindrical batteries are preferably power batteries with high energy density, and the size of the cylindrical batteries may be selected from Type 18650 batteries, Type 21700 batteries, and Type 46800 batteries, etc. Especially, new @46 mm series large-size cylindrical batteries are not put into mass production yet, and the industrial chain of associated components for the new batteries will be fire-new, and is especially suitable to add the new battery components in. However, the present invention is not limited to those batteries. It should be understood by those skilled in the art that cylindrical batteries of any size are suitable for use in the technical solution of this embodiment; in addition, batteries that are approximately cylindrical, such as batteries having a cross-sectional shape of rounded rectangle, rounded triangle, or rounded polygon, are also suitable for use in the technical solution of this embodiment, and all such batteries may be regarded as cylindrical batteries.

Besides, bare batteries and batteries with all the lateral shell coated with an insulating layer 14 are also applicable to the present invention. On a battery with the entire lateral shell coated with the insulating layer 14, the insulating layer 14 is sandwiched between the extending portion 13 and the lateral shell, as well as between the connecting portion 12 and the top end of the lateral shell. It should be understood by those skilled in the art that when a cylindrical battery with an insulating layer 14 is used, the insulating layer 14 should have one or more windows to expose the shell poles, so that the battery can be electrically connected to the lateral extending portion or the lateral shell of the adjacent battery.

### Embodiment 3

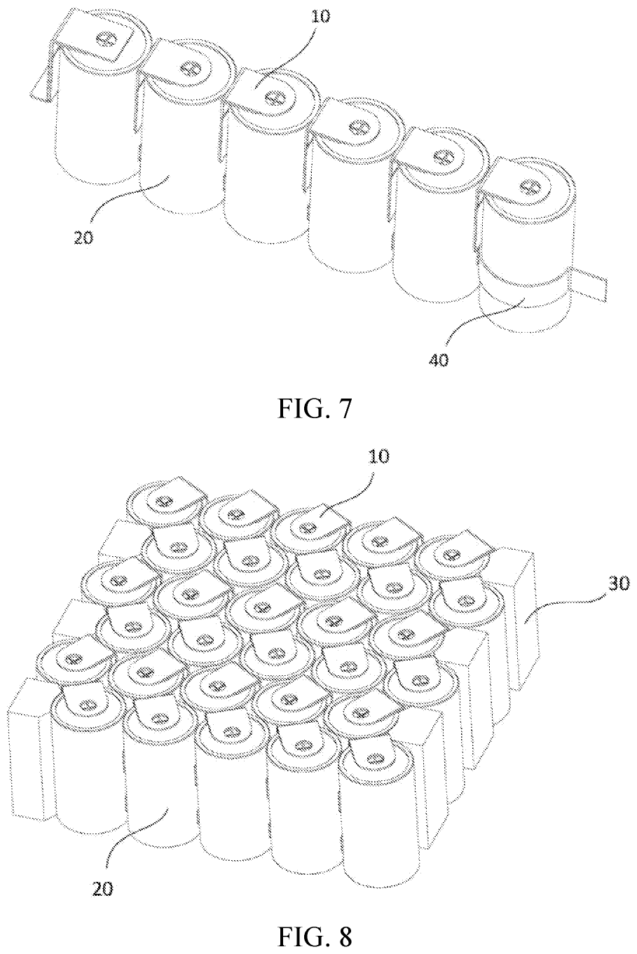

In Embodiment 3, a battery bank in series is provided. As shown in FIG. 7, the battery bank in series comprises a plurality of cylindrical batteries as described in the Embodiment 2.

A plurality of cylindrical batteries are arranged sequentially, the connection transferring piece of the first cylindrical battery in the battery bank serves as an external top pole of the battery bank; the extending portion 13 of each of the other cylindrical batteries in the battery bank are electrically connected to a lateral shell of the cylindrical shell 20 of the previous cylindrical battery sequentially, preferably the plane of the extending portion is perpendicular to a line connecting the centers of the circles of adjacent cylindrical batteries so that the extending portion can be pressed on the batteries at the two ends of the connecting line conveniently; the cylindrical shell 20 of the last cylindrical battery in the battery bank can serve as an external shell pole of the battery bank.

Preferably, as shown in FIG. 7, in the Embodiment 3, firstly, a battery bank in series solution in which a plurality of cylindrical batteries is arranged in a straight line is provided. Those skilled in the art should appreciate: if the left connecting line between the circle centers of one cylindrical battery and the left adjacent cylindrical battery and the right connecting line between the circle centers of one cylindrical battery and the right adjacent cylindrical battery formed by the arrangement of the one cylindrical battery and the left and right adjacent cylindrical batteries are not in the same line, the plane of the extending portion 13 of the cylindrical battery is always perpendicular to a line connecting the circle centers of the adjacent cylindrical batteries electrically connected to the cylindrical battery, the orientation of the extending portion 13 of each cylindrical battery will be deflected by an angle accordingly with the successive lines connecting the centers of the circles; the deflection angle is within a range of 0 to 160 degrees, and the upper limit of the deflection angle is related with the width of the connection transferring piece. The deflection angle may even be up to 170 degrees, provided that there is no interference. Therefore, the battery bank in series in this embodiment can provide a very flexible structure, for example, the batteries may be arranged in a broken line or curved line, etc.; in addition, a battery bank in series can be formed by adjacent cylindrical batteries regardless of the orientations of the positive poles and negative poles of the adjacent cylindrical batteries. Therefore, it is possible to apply the battery bank in application scenarios where a special structure is desired.

Preferably, the battery bank in series further comprises an outwardly bending portion of the extending portion 13 of the first cylindrical battery in the battery bank. The outwardly bending portion is located at the lower end of the extending portion 13, and corresponds to the part of a rigid insulating layer with single-sided adhesive. An external top pole of the battery bank is formed by bending the extending portion 13 outwardly. Since the insulating layer 14 corresponding to the upper portion of the extending portion is a double-sided adhesive and has been cured into an integral structure, the external top pole has improved external pulling resistance performance.

Preferably, the battery bank in series further comprises a connecting bridge 40 electrically connected to the cylindrical shell 20 of the last cylindrical battery in the battery bank, and the connecting bridge 40 can serve as an external shell pole of the battery bank. Preferably, one end of the connecting bridge 40 is electrically connected to the lateral shell at the inner side of the last cylindrical battery, and the other end of the connecting bridge 40 extends outside of the battery bank, and there is an insulating structure between the connecting bridge 40 and the lateral shell of the last but one cylindrical battery in the battery bank. The connecting bridge 40 partially surrounds the lateral shell of the last battery in the battery bank to increase the contact area. Preferably, the connecting bridge 40 is an extension portion of a long conducting plate that is bent for many times into a closed flat hollow conductor. After being squeezed by the lateral shells of two batteries at two sides, the hollow conductor is in an arc shape at both sides and fits into the cylindrical shells at the two sides. Thus, the external pulling resistance performance of the connecting bridge serving as an external shell pole of the battery bank is greatly improved.

Preferably, an electrical bridge structure and/or a cold-welding structure are/is provided between the extending portion 13 and the lateral shell of the cylindrical shell 20.

Preferably, the electrical bridge structure may be a hollow or solid conductor. Preferably, the hollow conductor is a closed flat hollow conductor formed by sequentially bending a conducting plate for at least two times; preferably, the hollow conductor may be a circular hollow conductor formed by electrically connecting conducting plates end to end, preferably the hollow conductor is in a flattened state. Preferably, the solid conductor is a solid conductor having a thermal breaking function, such as a low-melting metal or thermally-meltable columnar conductor.

Preferably, any of the above-mentioned electrical bridge structures may be provided together with a cold-welding structure to achieve a better electrical connection effect. For example, the hollow conductor may be coated with cold-welding adhesive at the outer sides and placed between the extending portion 13 and the lateral shell of the cylindrical shell 20 to increase the area and reliability of the electrical connection. Preferably, the hollow conductor is internally coated with cold-welding adhesive, and a direct channel between the two outer sides of the hollow conductors through the internal center of the hollow conductor is increased by the electrical channel between the extending portion and the cylindrical shell, besides the existing shell channel.

In a preferred embodiment, the electrical connection and structural connection of the battery bank in series are formed through a pure bonding process. That is to say, the electrical connection is formed through the above-mentioned cold-welding process, while the structural connection is formed by structural adhesive bonding. Such a purely bonded battery bank can be conveniently recycled and disassembled quickly without damage with a chemical disassembling method.

### Embodiment 4

In Embodiment 4, a battery bank with shell poles connected in shunt is provided first. The battery bank in shunt comprises a plurality of cylindrical batteries as described in the Embodiment 2. Each battery bank is formed by a plurality of afore-mentioned cylindrical batteries arranged in a row; the cylindrical shells 20 of adjacent cylindrical batteries in the same battery bank are electrically connected, thereby a battery bank with shell poles connected in shunt and top poles disconnected is formed. Preferably, the batteries in the battery bank are arranged in the same orientation and aligned in a straight line.

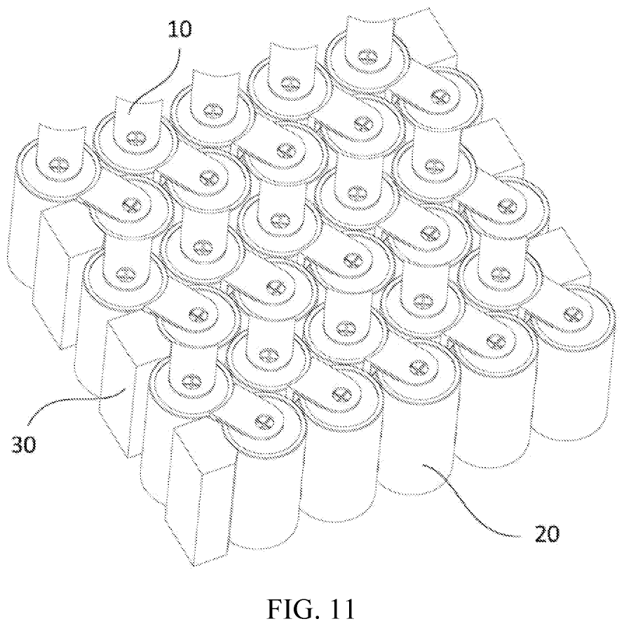

Furthermore, in the Embodiment 4, a battery pack is provided. As shown in FIGS. 8-11, the battery pack comprises:

A plurality of battery banks arranged in a staggered manner, with shell poles connected in shunt (hereafter simply referred to as a battery bank, i.e., it means that the battery bank with shell poles connected in shunt in this embodiment). Preferably, in two adjacent battery banks, the center of each cylindrical battery in one battery bank is opposite to a gap position between two cylindrical batteries in the other battery bank.

The extending portions of all cylindrical batteries in each battery bank are located at the same side of the battery bank, the extending portions of the cylindrical batteries in a plurality of battery banks are arranged in the same orientation, and each extending portion is oriented to the lateral shell of an adjacent cylindrical shell 20 in the adjacent battery bank, and is electrically isolated from other cylindrical batteries in the battery bank; preferably, the plane of the extending portion of a cylindrical battery is perpendicular to a line connecting the centers of the circles of adjacent cylindrical batteries electrically connected to the cylindrical battery; preferably, the orientation of the extending portion 13 that is, the extension direction of the connecting portion 12, forms an included angle of approximate 60 degrees with the battery bank.

The extending portions 13 of all cylindrical batteries in each battery bank are electrically connected to the lateral shells of the cylindrical shells 20 in the next battery bank sequentially; all cylindrical batteries in each battery bank are connected with each other in shunt, while the plurality of battery banks are connected with each other in series.

Preferably, at least one end of each battery bank is provided with a connection transferring bridge 30; the thickness of the connection transferring bridge 30 is substantially equal to the spacing of staggering between the battery bank and the adjacent battery bank. Preferably, the connection transferring bridge 30 further comprises an electrically connecting portion 12, the electrically connecting portion 12 may pass across/through the surface or the interior of the connection transferring bridge 30, one end of the electrically connecting portion 12 may be electrically connected to a certain cylindrical shell 20, preferably the adjacent cylindrical shell, in the corresponding battery bank, and the other end of the electrically connecting portion 12 is arranged at any position of the connection transferring bridge, so as to electrically connect to an external mechanism conveniently, thereby realizing battery bank expansion, balancing, monitoring, and other functions.

Preferably, a second electrically connecting portion 60 is provided between the extending portion 13 and the lateral shell of the corresponding cylindrical shell 20 in the adjacent battery bank, and a first electrically connecting portion 50 is provided between the extending portion 13 and the lateral shell of the adjacent cylindrical shell 20 in the same battery bank, and the first electrically connecting portion 50 and/or the second electrically connecting portion 60 have/has an electrical bridge structure and/or a cold-welding structure.

Preferably, the electrical bridge structure may be a hollow or solid conductor. Preferably, the hollow conductor is a closed flat hollow conductor formed by sequentially bending a conducting plate for at least two times; preferably, the hollow conductor may be a circular hollow conductor formed by conducting plates electrically connected from end to end, preferably in a flattened state. Preferably, the solid conductor is a solid conductor having a thermal breaking function, such as a low-melting metal or thermally-meltable columnar conductor. Preferably, any of the above-mentioned electrical bridge structures may be provided together with a cold-welding structure to achieve a better electrical connection effect. For example, the hollow conductor is provided with cold-welding adhesive inside and outside the hollow conductor, and is placed between the extending portion 13 and the lateral shell of the cylindrical shell 20 as well as between the extending portion 13 and the lateral shell of the adjacent cylindrical shell 20 in the battery bank.

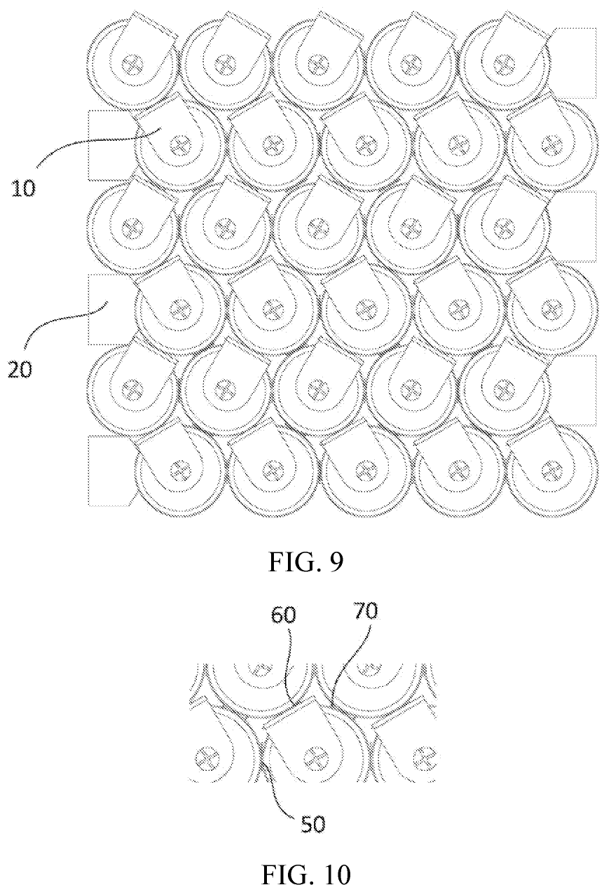

Preferably, the battery pack comprises an external top pole conflux portion, which is electrically connected to the extending portions of all cylindrical batteries in the first battery bank, that is, the topmost battery bank in FIG. 9. That is to say, the external top pole conflux portion is a single-layer conflux solution.

Preferably, the battery pack comprises an external top pole conflux structure, i.e., a tiered and multi-layer conflux solution. Specifically, the external top pole conflux structure comprises a tiered structure of external top pole conflux portions in a direction from a primary conflux portion at a side of the battery pack to the final external conflux portion, and the number of the conflux portions in the tiers is gradually reduced in the direction; the primary external top pole conflux portion consists of a plurality of conflux portions, each of the conflux portions is electrically connected to the extending portions of some corresponding cylindrical batteries in the first battery bank, and all conflux portions correspond to the extending portions of all cylindrical batteries in the first battery bank; preferably, the external top pole conflux structure may further comprise a secondary conflux portion, and the secondary conflux portion is a final conflux portion electrically connected to all external top pole conflux portions of the primary external top pole conflux portions internally and electrically connected to the external load externally, to realize grouped and tiered current confluence.

Preferably, the external top pole conflux structure is a two-tier structure, in which a primary top pole conflux portion are two external top pole conflux portions that are arranged successively and correspond to the same number of extending portions of cylindrical batteries respectively, and externally connected to the positive poles of two external loads connected in shunt; a conflux portion between the positive poles of the external loads connected in shunt is a final top pole conflux portion.

It should be understood by those skilled in the art that the plurality of external top poles of the battery pack can lower the requirement for the current-carrying capacity of a single top pole, and are primary top pole conflux portions in the tiered top pole conflux structure, and the final top pole conflux portion is the master external top pole of the battery pack.

Preferably, the extending portions of all cylindrical batteries in the first battery bank are oriented in a direction perpendicular to the orientation of the battery bank, and the external top pole conflux portion fits into the extending portion and is electrically connected to the extending portions. Preferably the orientation of the extending portions in this battery bank is different from that in the other battery banks, and the surfaces of all extending portions in this battery bank are in the same plane, so that they can fit into the external top pole conflux portion conveniently. It should be understood by those skilled in the art that it is not necessary to require that the extending portions of all cylindrical batteries in the first battery bank are oriented to a direction perpendicular to the orientation of the battery bank. The external top pole conflux portion may be configured in a shape that matches the side surfaces of the cylindrical shells in the first battery bank, so that a stable electrical connection could be realized almost in any orientation of the extending portions.

Preferably, the battery pack comprises a plurality of external shell poles, one end of each shell pole is electrically connected to the cylindrical shell of any cylindrical battery in the last battery bank, that is, the bottommost battery bank in FIG. 9, and each shell pole may be electrically connected to a load; the battery pack may be electrically connected to a plurality of loads simultaneously.

Preferably, the battery pack comprises an external shell pole conflux portion, which is electrically connected to the cylindrical shells of all cylindrical batteries in the last battery bank, that is, the bottommost battery bank in FIG. 9. That is to say, the external shell pole conflux portion is a one-tier structure. Alternatively, the battery pack comprises an external shell pole conflux structure, the external shell pole conflux structure comprises a plurality of external shell pole conflux portions that are electrically connected to the cylindrical shells of some cylindrical batteries in the last battery bank respectively. Preferably, the external shell pole conflux structure may further comprise a secondary conflux portion, which is electrically connected to all external shell pole conflux portions, to realize grouped and tiered current confluence.

Preferably, the above-mentioned external top pole conflux structure employs a tiered current conflux approach, i.e., some external top pole conflux portions are further connected to a secondary conflux portion that has higher current-carrying capacity. It should be understood by those skilled in the art that the external top pole conflux structure may have more tiers, such as three tiers, four tiers, or more tiers, and the plurality of external top pole conflux portions may be arranged evenly or unevenly. In that way, the number of conflux portions is reduced tier by tier, and the current-carrying capacity of the connecting bridges for current conflux is increased accordingly. This solution corresponds to the graded power distribution of a multi-motor electrical driving system.

Preferably, as shown in FIGS. 9-10, structural adhesive 70 is provided between the connection transferring bridge 30 and the cylindrical shell 20 of the cylindrical battery, and/or between the cylindrical shells 20 of the cylindrical batteries in the same battery bank, and/or between the cylindrical shells 20 of corresponding cylindrical batteries in adjacent battery banks. It should be understood by those skilled in the art that the structural adhesive 70 may also be provided at any position in the battery pack where the structural relationship is to be maintained. Preferably, the structural adhesive 70 is in a line connecting the centers of the circles of adjacent cylindrical batteries. The cured insulating structural adhesive 70 can prevent any short circuit between the batteries under the squeezing action, in addition to stabilizing the positional relationship between adjacent cylindrical batteries.

As shown in FIG. 9, the battery pack 100 is formed by arranging 5 cylindrical batteries 1 in each battery bank in the transverse direction and arranging six battery banks in the longitudinal direction, i.e., a 5×6 battery array. Of course, those skilled in the art should understand that the battery pack in this embodiment may be a 3×4 battery array, 6×8 battery array, 10×4 battery array, 8×20 battery array, or 8×40 battery array, etc. There is no restriction on the expansion of a battery pack in the transverse direction and the longitudinal direction in this embodiment.

In a preferred embodiment, the electrical connection and structural connection of the battery bank in shunt and battery pack in this embodiment are formed through a pure bonding process. That is to say, the electrical connection is formed through the above-mentioned cold-welding process, while the structural connection is formed by structural adhesive bonding. Such a purely bonded battery bank or battery pack can be conveniently recycled and disassembled.

In the battery pack in the Embodiment 4, even though there is no additional common busbar structure in the battery pack, i.e., there is no conflux component that runs across the entire battery bank, a grouping solution of shunt connection in each battery bank and serial connection between battery banks can still be realized.

### Embodiment 5

In this embodiment, a method for manufacturing the battery pack as described in the Embodiment 4 is provided. The manufacturing method comprises:
arranging a plurality of cylindrical batteries in a row in a single-row fixture, and adjusting the orientations of the connection transferring pieces of the cylindrical batteries to the same orientation according to the orientations of the connection transferring piece of the cylindrical batteries;
inserting a cold-welding structure and/or connecting bridge between the shells of adjacent batteries in the battery bank, and pressing from the two sides to form a linear battery bank in a fixed length, wherein the shell poles of all cylindrical batteries in the battery bank are connected in shunt;
preparing a plurality of battery banks;
arranging a plurality of battery banks in a master fixture in a staggered manner, with a battery bank with connecting bridges arranged in the last row; inserting cold-welding structures between the cylindrical shells 20 and the extending portions 13 in adjacent battery banks, pressing the plurality of battery banks in the direction between the battery banks, so that the top poles of the batteries in the battery banks are connected in shunt, thereby a battery pack with adjacent battery banks connected in series is obtained;
applying structural adhesive between adjacent batteries at the ends and two bottom sides of the battery pack with a multi-head adhesive dispenser, and irradiating ultraviolet light to the two sides to cure the structural adhesive;
removing the single-row fixture and the master fixture; thus, a cured battery pack is obtained;
electrically connecting the extending portions of the connection transferring pieces of all batteries in the first battery bank to the top pole conflux portions.

### Embodiment 6

In Embodiment 6, a solution for applying the above-mentioned battery pack in CTC is provided.

The top of the battery pack is provided with an insulating plate (rigid and wear-resistant), which has an elastic material (flexible, pressed against the non-planar top area of the batteries) on a side corresponding to the top of the battery pack. The elastic material has adhesive on a side corresponding to the top of the battery, the elastic material and the insulating plate are provided with through-holes corresponding to the pressure relief openings of the batteries, the insulating plate is used to electrically isolate the top of the batteries from the objects placed on top of the batteries and maintain pressure relief channels;

A combined battery box cover is provided above the insulating plate, the top part of the box cover is provided with structural parts for being fixed to objects in the vehicle, such as seats; the box cover is provided with reinforcing ribs to increase the bending strength of the box cover; battens are provided under the box cover to press the insulating plate, and the battens are locked to the lateral walls of the battery box or the chassis structure, to maintain an integral structure of the box cover and the battery pack.

Upwardly protruding bending strips are provided at positions corresponding to the battery box cover above the pressure relief openings in rows, and a heat-insulating material is provided inside the bending strips. Preferably, the bending strips serve as reinforcing ribs for the box cover and isolating compartments for collecting the heat released from the batteries in the case of thermal runaway, and then the collected heat is released from the pressure relief openings of the vehicle body at the two sides of the protruding bending strips to the external environment.

In the Embodiment 4, a chassis structure applicable to the above-mentioned battery pack is further provided:
1) The box bodies at the left side and the right side of the battery box are clamped between two cross beams of the chassis, thereby an integral structure is formed;
2) The top cover of the battery box is fixed to the lateral walls of the battery box or the top part of the cross beams, forming an integral structure with the lateral walls of the box body and the cross beams;
3) The upper surface of the top cover of the battery box is flush with the upper end faces of the cross beams, thereby a plate-shaped cross beam structure is formed; components in the vehicle can be arranged on the upper surface.
4) The sides of the battery box are the inner side walls of the cross beams at the two sides;
5) The bottom surface of the battery box is flush with the lower end faces of the cross beams, and the ground clearance of the bottom surface of the battery box is the ground clearance of the cross beams (entire vehicle).

### Embodiment 7

In Embodiment 7, a manufacturing method of the structure in the CTC solution described in the Embodiment 6 is provided. The manufacturing method comprises:
1) Forming the bottom/sides of the battery box and the structural parts of the vehicle chassis into an integral structure;
2) Adjusting the orientations of the batteries in a row according to the connection transferring pieces, arranging the batteries in a single-row fixture in a row, mounting connection transferring bridges 30, inserting cold-welding structures between the cylindrical shells 20 of adjacent batteries, pressing from the two sides, and forming a linear battery bank in fixed length, in which the batteries are connected in shunt;
3) Aligning individual single-row fixtures in a master fixture in a staggered manner, inserting cold-welding structures between the shells and the connection transferring pieces of adjacent batteries between the battery banks, pressing in the direction between the battery banks (the minimum distance between the battery banks is controlled by the thickness of the connection transferring bridges 30), aligning the batteries in an array in fixed width, and connecting the adjacent battery banks in series; thus, a battery pack is obtained;
4) Mounting functional components (e.g., PCB boards) on the sides of the battery pack (i.e., a battery array);
5) Applying structural adhesive 70 one time on the top and bottom end faces and sides of the battery array, between the lateral shells of adjacent batteries (near the end faces), between the PCB boards and the shells of the batteries, with a massive adhesive dispensing method, that is, simultaneously applying adhesive to multiple surfaces;
6) Curing the adhesive on the multiple surfaces simultaneously under ultraviolet light, to form an integral battery array structure; removing the single-row fixtures;
7) Spraying a quick-dry bonding layer (polyurea) on the bottom of the battery box;
8) Pressing the bottom of the battery array into a bonding layer, locking the lateral locking mechanisms of the battery box, removing the pressure on the sides of the battery array, and removing the master fixture, so that the battery array and the bottom/sides of the battery box form an integral structure;
9) Completing the electrically connections of the functional components to the battery array on the top surface of the battery array, and electrically connecting the external poles of the battery array to the external poles of the box body;
10) Mounting pressing and locking devices for the battery array between the top surface of the battery array and the bottom/sides of the battery box;
11) Locking the bottom part of the combined top cover of battery box having top structural connectors to the bottom/sides of the battery box and the chassis structure of the vehicle, so that the battery box and the chassis structure form an integral structure.

While some embodiments of the present invention are described above with reference to the accompanying drawings, the present invention is not limited to those embodiments. The embodiments described above are only illustrative rather than limiting. Various modifications and alternations may be made by those having ordinary skills in the art inspired by the present invention without departing from the spirit of the present invention and the scope of protection defined by the claims. However, all of such modifications and alternations shall be deemed as falling in the scope of protection of the present invention.

1. A packaging structure of a cylindrical battery, comprising:
a cylindrical shell having an open end;
a combined top cover including a top cover body and a connection transferring piece; wherein the top cover body is a conductor arranged at the open end of the cylindrical shell to close the open end;
the connection transferring piece is a conductor and has a bending portion, and the two ends of the bending portion serve as a connecting portion and an extending portion of the connection transferring piece respectively; the connecting portion is electrically connected to the top cover body; the inner side of the extending portion is arranged adjacent to a lateral shell of the cylindrical shell and is not electrically connected to the cylindrical shell; and the outer side of the extending portion is configured to electrically connect to the shell pole of another cylindrical battery.

2. The packaging structure of claim 1, wherein the top cover body is provided with a pressure relief portion; the pressure relief portion is arranged at the center of the top cover body, or the pressure relief portion is arranged at a position offset from the center of the top cover body.

3. The packaging structure of claim 1, wherein an annular electrically connecting structure is provided on the side of the connecting portion that faces the top cover body, and the annular electrically connecting structure electrically connects the top cover body with the connection transferring piece.

4. The packaging structure of claim 3, wherein at least a portion of the area of the connecting portion fits into the top cover body and is electrically connected to the top cover body.

5. The packaging structure of claim 3, wherein the connecting portion and the annular electrically connecting structure are integrally formed, and the annular electrically connecting structure and the top cover body are connected by a hot-welding process or a cold-welding process.

6. The packaging structure of claim 3, wherein the connecting portion, the annular electrically connecting structure and the top cover body are integrally formed.

7. The packaging structure of claim 1, wherein at least a portion of the inner area of the extending portion and/or at least a portion of the inner area of the connecting portion are/is provided with an insulating layer; the insulating layer is configured to insulate the connection transferring piece from the cylindrical shell.

8. The packaging structure of claim 7, wherein at least a portion of the inner area of the extending portion is covered with a hard insulating layer, the hard insulating layer is double-sided adhesive.

9. The packaging structure of claim 1, wherein the connecting portion is provided with a pressure relief hole at a position corresponding to the pressure relief portion.

10. A cylindrical battery, comprising the packaging structures of the cylindrical battery according to claim 1 and a battery cell assembly;
the battery cell assembly is arranged inside a closed space enclosed by the cylindrical shell and the top cover body;
the top pole of the battery cell assembly is electrically connected to the top cover body and/or the connecting portion, the shell pole of the battery cell assembly is electrically connected to the cylindrical shell, and the periphery of the top cover body is connected to the cylindrical shell in an insulated and sealed manner.

11. A battery bank connected in series, comprising a plurality of cylindrical batteries according to claim 10,
the plurality of cylindrical batteries are arranged sequentially, the extending portion of the first cylindrical battery in the battery bank serves as an external top pole of the battery bank, the extending portion of each of the other cylindrical batteries in the battery bank is electrically connected to a lateral shell of the cylindrical shell of a previous cylindrical battery sequentially, and the cylindrical shell of the last cylindrical battery in the battery bank can serve as an external shell pole of the battery bank.

12. The battery bank connected in series of claim 11, wherein the plurality of cylindrical batteries is arranged in a straight line, a broken line or a curved line.

13. The battery bank connected in series of claim 11, wherein an electrical bridge structure and/or a cold-welding structure and/or a structural adhesive bonding and encapsulating structure are/is arranged between the extending portion and the lateral shell of the cylindrical shell.

14. A battery pack, comprising:
a plurality of battery banks arranged in a staggered manner, each of battery banks is consisted of a plurality of cylindrical batteries according to claim 10; wherein the cylindrical shells of adjacent cylindrical batteries in the same battery bank are electrically connected;
the extending portions of all cylindrical batteries in each battery bank are at the same side of the battery bank and face the lateral shells of the cylindrical shells in the adjacent battery bank;
the extending portions of all cylindrical batteries in each battery bank are electrically connected to the lateral shells of the adjacent cylindrical shells in the next battery bank sequentially; and
all cylindrical batteries in each battery bank are connected with each other in shunt, while the plurality of battery banks are connected with each other in series.

15. The battery pack of claim 14, wherein at least one end of each battery bank is provided with a connection transferring bridge; the thickness of the connection transferring bridge is substantially equal to the staggered distance between the battery bank and the adjacent battery bank.

16. The battery pack of claim 14, wherein the extending portions of all cylindrical batteries in each battery bank are oriented to a direction that is at the same included angle from the orientation of the battery bank.

17. The battery pack of claim 14, wherein an electrical bridge structure and/or a cold-welding structure and/or a structural adhesive bonding and encapsulating structure are/is provided between the extending portion and the lateral shell of the corresponding cylindrical shell in the adjacent battery bank as well as between the extending portion and the lateral shell of the adjacent cylindrical shell in the battery bank.

18. The battery pack of claim 14, wherein the battery pack comprises an external top pole conflux portion, the external top pole conflux portion is electrically connected to the extending portions of all cylindrical batteries in the first battery bank;
alternatively, the battery pack comprises an external top pole conflux structure, the external top pole conflux structure comprises a plurality of external top pole conflux portions that are electrically connected to the extending portions of some cylindrical batteries in the first battery bank respectively.

19. The battery pack of claim 18, wherein the extending portions of all cylindrical batteries in the first battery bank are oriented in a direction perpendicular to the orientation of the battery bank, and the external top pole conflux portion fits into the extending portions and is electrically connected to the extending portions.

20. A method for manufacturing the battery pack of claim 14, comprising the following steps:
arranging a plurality of cylindrical batteries in a row in a single-row fixture, and adjusting the orientations of the connection transferring pieces of each of the cylindrical batteries to the same orientation according to the orientations of the connection transferring pieces of the cylindrical batteries;
inserting a cold-welding structure between the cylindrical shells of adjacent cylindrical batteries in the battery bank, and pressing from the two sides to form a linear battery bank in a fixed length, wherein the cylindrical shells of all cylindrical batteries in the battery bank are connected in shunt;
preparing a plurality of the battery banks; and
arranging the plurality of battery banks in a staggered manner in the whole fixture, inserting a cold-welding structure between the cylindrical shells of the adjacent battery banks and the extending portions, pressing the plurality of battery banks together in the inter-bank direction, so that the cylindrical shells of corresponding cylindrical batteries in adjacent battery banks are electrically connected to the extending portions, so as to obtain a battery pack in which adjacent battery banks are connected in series.
